(19) United States
(12) Patent Application Publication
(10) Pub. No.: US 2010/0044642 A1
(43) Pub. Date: Feb. 25, 2010

(54) REACTOR DEVICE, AND A METHOD FOR CARRYING OUT A REACTION WITH HYDROGEN AS REACTION PRODUCT

(75) Inventors: Jan Wilco Dijkstra, Grootebroek (NL); Steven Cornelis Antonius Kluiters, Delfgauw (NL); Yvonne Christine Van Delft, Petten (NL)

Correspondence Address: YOUNG & THOMPSON, 209 Madison Street, Suite 500, Alexandria, VA, 22314, US

(73) Assignee: STICHTING ENERGIEONDERZOEK CENTRUM NEDERLAND, Petten (NL)

(21) Appl. No.: 12/299,510

(22) PCT Filed: May 1, 2007
(86) PCT No.: PCT/NL2007/050192

§ 371 Date: Jun. 8, 2009

(30) Foreign Application Priority Data
May 4, 2006 (NL) 1031754

(51) Int. Cl. C01B 3/02; B01J 19/00; C01C 1/04; C01B 3/38

(52) U.S. Cl. 252/373; 422/187; 423/648.1; 423/359

(57) ABSTRACT

A reactor device comprises a reaction chamber for carrying out a reaction with hydrogen (H2) as reaction product. The reactor device comprises a combustion chamber, and a hydrogen-permeable membrane, which is provided between the reaction chamber and the combustion chamber. A supply channel is provided in the combustion chamber. The supply channel is designed, for example, as a tubular supply line. The supply channel is provided with lateral supply apertures for supplying a fluid containing oxygen (O2), such as air, to the combustion chamber.

The invention relates to a reactor device, comprising a reaction chamber for carrying out a reaction with hydrogen (H₂) as reaction product, a combustion chamber, and a hydrogen-permeable membrane, which is provided between the reaction chamber and the combustion chamber.

WO 03/031325 discloses a so-called reformer reactor for producing a synthesis gas (“syngas”) from natural gas. A syngas is a gas mixture substantially comprising carbon monoxide (CO) and hydrogen (H₂). This reformer reactor comprises a reaction chamber with an inlet for a supply stream of natural gas (CH₄) and water (H₂O) and an outlet for syngas. The reaction chamber is bounded in the circumferential direction by a membrane, which is substantially permeable only to hydrogen. The membrane is surrounded by a permeate chamber, which also forms a combustion chamber. The combustion chamber has an air inlet and an outlet aperture.

During operation the supply stream of natural gas and water is fed to the reaction chamber, in which so-called steam reforming occurs. In this process carbon monoxide and hydrogen are formed from the natural gas and the water. A product stream substantially containing syngas is produced in the reaction chamber. The product stream leaves the reaction chamber through the outlet.

Since steam reforming is an endothermic reaction, heat has to be supplied in order to maintain the reaction. The quantity of hydrogen conveyed through the hydrogen-permeable membrane is dependent upon the partial pressure of hydrogen in the reaction chamber and the combustion chamber. The partial pressure of hydrogen is determined by the molar fraction of hydrogen multiplied by the absolute pressure. During operation the partial pressure of hydrogen in the reaction chamber is higher than that in the combustion chamber. A quantity of the hydrogen formed will consequently pass out of the reaction chamber through the membrane and into the combustion chamber. In addition, air is supplied through the air inlet to the combustion chamber, so that combustion of the hydrogen occurs in the combustion chamber. In this process heat is released, which provides the endothermic steam reforming with heat and ensures that the temperature of the reaction chamber remains sufficiently high for the steam reforming.

Because a portion of the hydrogen formed is combusted for heating the reaction chamber, a separate combustion chamber is not necessary. After all, the permeate chamber in which the hydrogen produced is captured and the combustion chamber are combined in one chamber. This leads to a simple design. Furthermore, the conveyance of hydrogen through the membrane is increased by the combustion of a portion of the hydrogen on the permeate side, since the combustion reaction lowers the partial pressure of hydrogen on the permeate side. Moreover, the combustion of a portion of the hydrogen formed can produce efficiency advantages compared with providing the necessary heat by combustion of a quantity of natural gas in a separate combustion chamber.

In the permeate chamber or combustion chamber, however, combustion that is unevenly distributed over the combustion chamber occurs. The air inlet is provided near an end of the combustion chamber, so that the combustion near the air inlet proceeds in a different way from that at a distance from said air inlet. As a result of this, the temperature in the reaction chamber is not evenly distributed over the reaction chamber either—the temperature in the reaction chamber can differ locally in each case. Local temperature peaks occur in the reaction chamber. The temperature differences over the reaction chamber influence the steam reforming that occurs in said reaction chamber. This adversely affects the controllability of the steam reforming. Furthermore, the uneven temperature distribution can impair the service life and the stability of the catalyst and the membrane. The temperature peaks can also have an adverse effect on the walls of the reactor device.

An object of the invention is to provide an improved reactor device.

This object is achieved according to the invention in that a supply channel is provided in the combustion chamber, which supply channel is provided with lateral supply apertures for supplying a fluid containing oxygen (O₂) to the combustion chamber. The fluid containing oxygen is, for example, air. The supply apertures distribute said air more evenly over the combustion chamber, the air being supplied so that it is distributed over the combustion chamber. The combustion of the hydrogen in the combustion chamber is consequently metered and controlled. This leads to a temperature in the combustion chamber, of the membrane and in the reaction chamber, which is more evenly distributed. Furthermore, the permeation of hydrogen through the membrane is also more even. The steam reforming process in the reaction chamber is consequently more even.

It is noted that EP967005 discloses a reactor for steam reforming of a hydrocarbon such as methanol. This reactor has an oxidation chamber and a reformer chamber provided downstream of said oxidation chamber, which chambers are interconnected by means of a deflection space. Between the oxidation chamber and the reformer chamber is a dense, heat-conducting dividing wall. On the side opposite the dividing wall the reformer chamber has a hydrogen-permeable membrane. A hydrogen discharge chamber is situated on the permeate side of the membrane.

The oxidation chamber and the reformer chamber form two steps on the supply side of the membrane. Methanol is supplied to the oxidation chamber, in which a portion of the methanol supplied oxidizes. Oxygen is required for this, and it is supplied through a supply line with lateral supply apertures. During the oxidation, heat is released, and this heat is transferred by way of the heat-conducting dividing wall to the endothermic steam reforming in the reformer chamber. The non-combusted portion of the methanol supplied leaves the oxidation chamber and passes through the deflection space into the reformer chamber. Supplying water to the inlet of the oxidation chamber or to the deflection space means that water is present in the reformer chamber, so that steam reforming can occur. The hydrogen formed in the process is conveyed through the membrane to the hydrogen discharge chamber.

The supply line with lateral supply apertures meters the air supplied in an evenly distributed manner into the oxidation chamber. The steam reforming in the reformer chamber is controllable by regulating the supply of oxygen. When the oxygen supply is increased, more methanol oxidizes and the heat transfer increases. Conversely, if the temperature in the reformer chamber is too high, the oxygen supply, and consequently the heat transfer, can be reduced, so that the temperature in the reformer chamber is reduced to a desired reforming temperature.

The supply line with lateral supply apertures is not, however, provided on the permeate side of the hydrogen-permeable membrane, but in the oxidation chamber on the supply side of the membrane. The oxidation chamber forms a separate heating chamber for heating the reformer chamber. Moreover, combustion of the methanol supplied occurs, and not combustion of permeated hydrogen. Furthermore, heat is not transferred over the membrane. This means that the partial pressure of hydrogen on the permeate side of the membrane is relatively high, which adversely affects the conveyance of hydrogen through the membrane.

In addition, it is noted that U.S. Pat. No. 4,990,714 discloses a reactor with a reaction zone to which a supply stream is fed in through a fluid distributor. In the reaction zone an endothermic reaction is carried out with hydrogen as reaction product. The hydrogen formed diffuses through a hydrogen-permeable membrane into a combustion zone surrounding the reaction zone. Air flows through supply lines into the combustion zone, in which combustion of hydrogen occurs. The heat released is transferred to the reaction zone. The air is, however, not supplied so that it is distributed to the combustion zone by means of a supply channel with lateral supply apertures. The fluid distributor conveys only the supply stream and is not provided in the combustion zone, but in the reaction zone.

It is furthermore noted that WO 2004/022480 discloses a device for producing hydrogen by steam reforming. This device is a membrane steam reforming reactor with flameless distributed combustion (FDC). The reactor comprises a central permeate chamber, which is surrounded by an annular reaction chamber. The permeate chamber and the reaction chamber are separated from each other by a hydrogen-permeable membrane. The reaction chamber is surrounded by an outside heating chamber in which FDC tubes are provided. Between the reaction chamber and the heating chamber is a dense dividing wall.

During operation natural gas and water are supplied to the reaction chamber, in which steam reforming occurs. The hydrogen formed diffuses through the membrane to the central permeate chamber. A flushing gas can flow through the permeate chamber in order to promote the conveyance of hydrogen through the membrane. The hydrogen leaves the central permeate chamber through an outlet.

In order to keep the endothermic reforming reaction going, combustion of natural gas is carried out in the heating chamber. Air flows in at one head end of the combustion chamber, while the natural gas is distributed over the heating chamber by means of the FDC tubes. The heat released by the combustion is transferred to the reaction chamber, so that the temperature inside the reaction chamber remains sufficiently high for steam reforming.

In one embodiment the combustion chamber is situated on the permeate side of the hydrogen-permeable membrane. The combustion chamber can be designed for combusting hydrogen which is conveyed out of the reaction chamber through the hydrogen-permeable membrane. The result is that the partial pressure of hydrogen in the combustion chamber decreases on the permeate side, so that the conveyance of hydrogen through the hydrogen-permeable membrane is increased.

In one embodiment the combustion chamber is thermally in contact with the reaction chamber by way of the hydrogen-permeable membrane. For example, the heat produced by combustion of hydrogen is transferred to the reaction chamber by means of heat conduction over the membrane.

It is possible according to the invention for the combustion chamber to be provided with an inlet aperture for the fluid containing oxygen (O₂), for example air, which inlet aperture is connected to the supply channel with the lateral supply apertures. Said inlet aperture does not open directly into the combustion chamber; the fluid containing oxygen flows from the inlet aperture through the supply channel with the lateral apertures in a distributed manner into the combustion chamber.

It is preferable according to the invention for the combustion chamber to be provided with an inlet for a flushing fluid. The flushing fluid comprises, for example steam and/or nitrogen, which may or may not be mixed with a fluid containing oxygen (O₂), such as air. The inlet for the flushing fluid forms a second inlet aperture. During operation a flushing stream can flow through the combustion chamber. The flushing stream promotes the conveyance of hydrogen through the hydrogen-permeable membrane.

In one embodiment of the invention the combustion chamber is provided with an outlet for at least hydrogen, which is conveyed out of the reaction chamber through the hydrogen-permeable membrane. The outlet can discharge, for example, pure hydrogen or hydrogen mixed with the flushing fluid. The reactor device can be used for producing hydrogen. In that case hydrogen is taken as far as possible through the membrane to the combustion chamber; the hydrogen then forms a main product on the permeate side. That hydrogen then flows out of the outlet to the combustion chamber. The combustion product water (H₂O) also leaves the combustion chamber through that outlet, since the combustion of hydrogen produces water, which is also discharged.

It is possible according to the invention for the reaction chamber to be provided with a supply point for supplying a supply stream. In particular, the supply stream comprises methane and water. The supply stream can, however, comprise any hydrocarbon that has hydrogen as the reaction product through an endothermic reaction with water. For example, a methanol/water mixture can also be used. Moreover, the supply stream can also comprise carbon monoxide, hydrogen and carbon dioxide, for example through the fact that the supply stream has already undergone a partial reaction, such as reforming or pre-reforming, prior to flowing into the reaction chamber.

In one embodiment of the invention the reaction chamber is provided with a discharge or discharge point for discharging a non-reacted supply stream and products and by-products formed by the reaction, such as CO₂, H₂O, H₂, CH₄ and CO. The reactor device can also be used for producing syngas. In that case only such a quantity of hydrogen as is needed to provide the endothermic reaction in the reaction chamber with heat is passed through the membrane to the combustion chamber. Considerable quantities of carbon monoxide, hydrogen and carbon dioxide are then present in the reaction chamber. The syngas flows out of the discharge of the reaction chamber.

The reaction chamber can furthermore be provided with a catalytic bed. The catalyst in the bed has an advantageous effect on the reaction in the reaction chamber. Besides, the oxidation reaction on the permeate side, i.e. in the combustion chamber, can also be supported by a catalyst.

According to the invention, the supply channel can be designed in various ways. For example, the supply channel comprises a tubular supply line in which the lateral supply apertures are accommodated. In addition, the supply channel can be formed between two plates placed at a distance from each other, in which plates the supply apertures are provided.

It is preferable according to the invention that the reaction chamber is designed for an endothermic reaction. In this case the lateral supply apertures can be designed in such a way that the heat production through combustion of hydrogen in the combustion chamber is adapted to the heat requirement of said endothermic reaction in the reaction chamber. This does not mean, however, that that heat production has to be exactly the same locally as that heat requirement.

In particular, the size of the supply apertures and/or the distances between them and/or their positioning over the supply channel is/are such that the heat production in the combustion chamber is adapted to the heat requirement in the reaction chamber. The size of the inlet apertures and/or the distances between them and/or their positioning over the supply channel constitute(s) design parameters. Through their optimization, temperature peaks in the reaction chamber can be largely avoided. Such design parameters can otherwise be used for achieving a desired temperature distribution when there is an exothermic reaction in the reaction chamber.

If the supply channel is in the form of a tubular supply line, the supply apertures can be distributed in its longitudinal direction. A supply channel formed between plates has, for example, supply apertures spread over the entire surface of the plate. In practice, the supply apertures are usually provided at substantially unequal distances from each other. The distribution of the supply apertures is then unequal.

It is possible according to the invention that a supply or supply point for supplying a fluid containing oxygen (O₂) is provided in the reaction chamber. This means that a portion of the supply stream in the reaction chamber can oxidize, while oxidation of permeated hydrogen also occurs in the combustion chamber. This is advantageous, for example, in the case of ammonia production.

In a special embodiment of the invention a reactor vessel is provided, which is provided with a number of hydrogen-permeable membranes, each membrane bounding a combustion chamber, the reaction chamber extending between the combustion chambers, and each combustion chamber being provided with a supply channel that is provided with lateral supply apertures for supplying a fluid containing oxygen (O₂). The reactor vessel is suitable for, for example, carrying out an endothermic reaction with hydrogen as reaction product on an industrial scale.

It is possible here that the reactor vessel has a supply aperture for a supply stream which opens into the reaction chamber between the combustion chambers bounded by the hydrogen-permeable membranes. The space between the combustion chambers forms a common reaction chamber, in which the endothermic reaction for forming hydrogen occurs. From the reaction chamber the hydrogen penetrates through the membranes into the combustion chambers, which are distributed in the reaction chamber of the reactor vessel.

According to the invention, the hydrogen-permeable membrane can define a tubular combustion chamber. The hydrogen-permeable membrane in this exemplary embodiment is tubular. The combustion chamber extends inside said tubular membrane. The combustion chamber is surrounded by the reaction chamber outside the membrane.

In a special embodiment of the invention each tubular supply line is provided with at least one central tube for passing through flushing fluid to an end part of the reactor, which central tube extends inside the supply line, the inlet for the flushing fluid of each combustion chamber being provided in said central tube near the end part. The supply line and the central tube in this case form two substantially concentric channels. If the reactor is set up in a vertical position, the channel running inside the central tube conducts the flushing stream downwards, so that the flushing stream flows from the bottom upwards through the combustion chamber. During operation, air flows through the annular channel that runs outside the central tube and inside the supply line. Perforations, which form the supply apertures for supplying air, are provided in the wall of the supply line. The combustion chamber is situated between the wall of the supply and the hydrogen-permeable membrane.

The invention also relates to a method for carrying out a reaction in which hydrogen (H₂) is formed as reaction product, comprising:
providing a reaction chamber and a combustion chamber, which chambers are separated from each other by a hydrogen-permeable membrane, which combustion chamber has a supply channel for a fluid containing oxygen (O₂) which is provided with lateral supply apertures,
carrying out said reaction in the reaction chamber,
transferring or conveying the hydrogen from the reaction chamber to the combustion chamber through the hydrogen-permeable membrane,
supplying the fluid containing oxygen (O₂) to the combustion chamber through the supply apertures of the supply channel,
combusting a quantity of hydrogen in the combustion chamber with the release of heat,
transferring said heat to the reaction chamber.

The heat can be transferred to the reaction chamber in various ways. For example, said heat is transferred from the combustion chamber to the reaction chamber by means of heat conduction through the hydrogen-permeable membrane.

It is possible according to the invention that the reaction carried out in the reaction chamber is endothermic, the heat transferred to the reaction chamber being used for maintaining said endothermic reaction. The endothermic reaction can be any endothermic equilibrium reaction with hydrogen as reaction product, such as converting a hydrocarbon, dehydrogenation or steam reforming. An example of dehydrogenation is the dehydrogenation of propane to propene.

In addition, the reaction carried out in the reaction chamber can be exothermic. An exothermic reaction then occurs both in the combustion chamber and in the reaction chamber. The invention is also suitable for such an exothermic reaction in the reaction chamber.

It is possible according to the invention that hydrogen is discharged from the combustion chamber through an outlet. In this case it relates to production of hydrogen.

In this process the hydrogen discharged from the combustion chamber can be fed to a gas turbine for generating electricity. The invention therefore also relates to a system for generating electricity, comprising a reactor device of the type described above, and also a gas turbine comprising a compressor, a combustion space and a turbine, the combustion chamber of the reactor device, in particular its outlet, being connected to the combustion space of the gas turbine for the purpose of supplying hydrogen to the latter. The hydrogen produced with the reactor device according to the invention can be fed to a gas turbine of a power station. The invention therefore also relates to the use of the hydrogen produced with the reactor device according to the invention for generating electricity with a gas turbine.

It is furthermore possible according to the invention that the hydrogen discharged from the combustion chamber is fed together with nitrogen to an ammonia reactor for producing ammonia (NH₃). The invention also relates to a system for producing ammonia, comprising a reactor device of the type described above, and also an ammonia reactor, the combustion chamber of the reactor device, in particular its outlet, being connected to the ammonia reactor for supplying hydrogen mixed with nitrogen in a ratio of substantially 3:1. The hydrogen produced with the reactor device according to the invention is also particularly suitable for use in the production of ammonia. The invention therefore also relates to the use of the hydrogen that is produced with the reactor device according to the invention for ammonia production.

The invention can furthermore be used for the production of syngas. In this case syngas is discharged from the reaction chamber through a discharge. Said syngas can be used to fuel a power station for generating electricity. The invention therefore also relates to the use of syngas that is produced with the reactor device according to the invention for generating electricity with a gas turbine.

Of course, a combination of hydrogen production and syngas production is also possible. In this case simultaneous discharge of hydrogen from the combustion chamber and syngas from the reaction chamber occurs.

The invention will now be explained in greater detail with reference to the appended drawing.

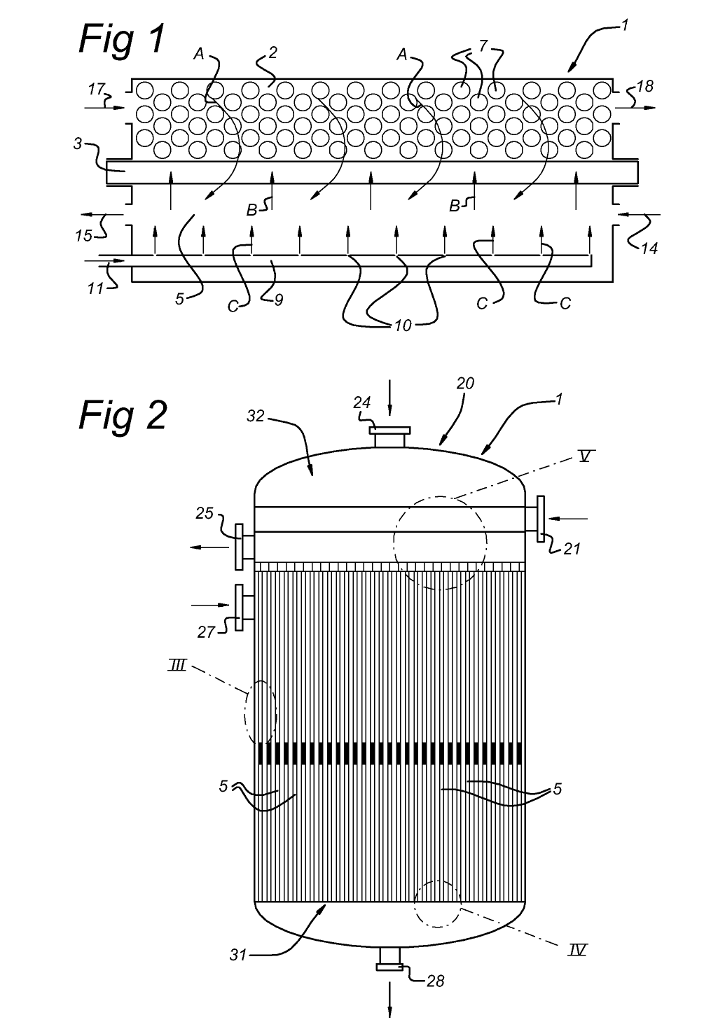

FIG. 1 shows diagrammatically the operating principle of carrying out a reaction with hydrogen as reaction product according to the invention.

FIG. 2 shows a reactor vessel for producing a gas mixture with hydrogen according to the invention.

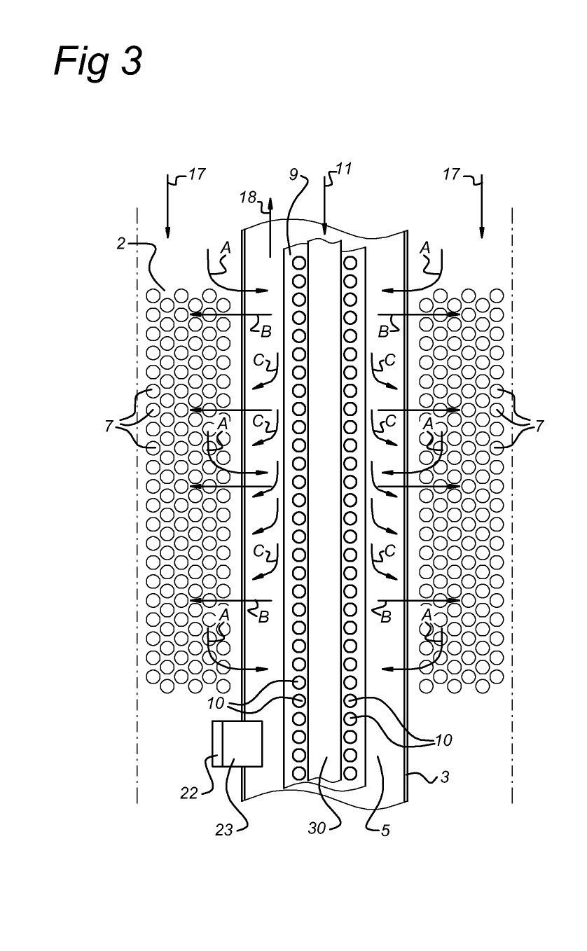

FIG. 3 shows a detail III from FIG. 2.

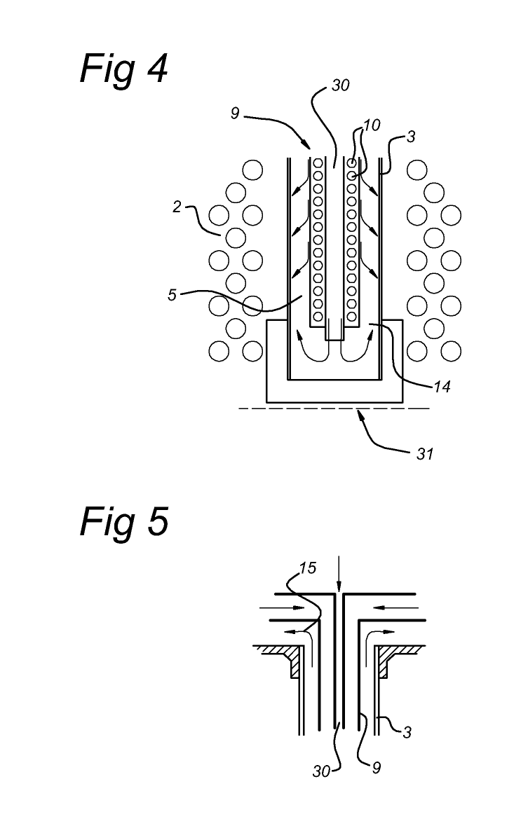

FIG. 4 shows a detail IV from FIG. 2.

FIG. 5 shows a detail V from FIG. 2.

The reactor device for carrying out a reaction with hydrogen (H₂) as the reaction product is indicated in its entirety by 1. The operating principle of the device 1 is indicated diagrammatically in FIG. 1.

The device 1 comprises a reaction chamber 2, which has a supply or supply point 17 for a supply stream. The supply stream comprises, for example, a mixture of natural gas (CH₄) and water (H₂O). The supply stream can, of course, comprise any other gas mixture from which hydrogen (H₂) can be released.

So-called steam reforming of the supply stream, for example, occurs in the reaction chamber 2. Steam reforming is an endothermic equilibrium reaction, in which carbon monoxide (CO) and hydrogen are formed from natural gas and water. The carbon monoxide and hydrogen form syngas. In reaction equation:

CH₄+H₂O+heat [symbol] CO+3 H₂.

The carbon monoxide formed reacts with water from the supply stream in the reaction chamber 2 to form carbon dioxide (CO₂) and hydrogen. This equilibrium reaction is called a water gas shift reaction. In reaction equation:

CO+H₂O [symbol] CO₂+H₂.

These two equilibrium reactions produce the following as a total reaction in the reaction chamber 2:

CH₄+2 H₂O+heat [symbol] CO₂+4 H₂.

The reaction chamber 2 comprises a catalytic bed of catalyst particles 7. The catalytic bed supports the steam reforming in the reaction chamber 2.

The reaction chamber 2 is bounded by a hydrogen-permeable membrane 3. The membrane 3 is substantially hydrogen-permeable, but forms a barrier to, for example, carbon dioxide. The hydrogen-permeable membrane 3 comprises, for example, a layer 22 of palladium or silver or an alloy of these materials (see FIG. 3). The hydrogen molecules can diffuse through the metal grille of such a layer. The layer 22 is applied to a substrate layer 23, such as a ceramic layer or a metallic layer, with or without one or more ceramic intermediate layers.

A partial pressure of hydrogen which is greater than that of the permeate side prevails in the reaction chamber 2. Hydrogen formed by steam reforming will leave the reaction chamber 2 through the membrane 3. Said hydrogen then goes into a combustion chamber 5 of the device 1. The penetration of hydrogen through the membrane 3 is indicated diagrammatically by arrows A. The membrane 3 is provided between the reaction chamber 2 and the combustion chamber 5. The combustion chamber 5 is situated on the permeate side of the membrane 3.

The reaction chamber 2 furthermore has a discharge or discharge point 18 for discharging a retentate stream. The retentate stream comprises reaction products, non-reacted supply stream and by-products, such as CO₂, H₂O, H₂, CH₄ and CO.

The combustion chamber 5 on the permeate side of the membrane 3 comprises an inlet 14 for a flushing fluid, such as steam (H₂O) and/or nitrogen (N₂). The flow of such a flushing fluid is often called a sweep. The flow of a flushing fluid through the combustion chamber 5 leads to a considerable improvement of the conveyance of hydrogen through the membrane 3.

The combustion chamber 5 in this exemplary embodiment comprises a tubular supply line 9. The supply line 9 has a series of lateral supply apertures 10 for supplying air to the combustion chamber 5. Incidentally, instead of air, any other oxidative fluid can be fed in, in particular any fluid containing oxygen. For example, the supply line 9 can also supply depleted air, or air to which steam has been added, to the combustion chamber 5. This air supply is indicated diagrammatically by arrows C.

The supply apertures 10 are distributed in the longitudinal direction along the supply line 9. The supply apertures 10 extend along the full length of the supply line 9. Although the distance between successive supply apertures 10 is shown to be approximately the same in each case in the drawing, that distance will usually differ, since that distance is one of the design parameters for adapting the heat production in the combustion chamber to the heat requirement in the reaction chamber.

By means of the tubular supply line 9, the air is supplied so that it is distributed over the full combustion chamber 5. The air supplied mixes with the hydrogen that has come into the combustion chamber 5 through the membrane 3. A quantity of said hydrogen, for example 20%, will combust as a result of this.

The heat released in the process is transferred to the supply stream in the reaction chamber 2. This heat transfer is indicated diagrammatically by arrows B. Since the supply apertures distribute the air substantially evenly over the combustion chamber 5, the heat released is also distributed substantially evenly. A virtually homogeneous temperature prevails in the combustion chamber 5. The heat production in the combustion chamber 5 is consequently adapted to the heat requirement of the endothermic steam reforming in the reaction chamber 2. As a result of this, the steam reforming in the reaction chamber 2 proceeds in a controlled manner. Furthermore, heat transfer to the air in the tubular supply line will also occur.

The combustion chamber 5 furthermore has an outlet 15 for hydrogen which is not combusted. The flushing fluid can also leave the combustion chamber S through the outlet 15, as can the combustion products, which in this case substantially comprise water.

The flows in the reaction chamber 2 and the combustion chamber 5 are in counterflow in FIG. 1. Instead of this, these flows can also be in co-current or parallel flow. The same applies to the flow in the tubular supply line, which can either be in co-current or parallel flow or in counterflow to the flow in the reaction chamber 2 and/or the combustion chamber 5.

FIG. 2 shows an exemplary embodiment of the device for producing a gas mixture with hydrogen, which device can be used on an industrial scale. In FIGS. 2-5 the same parts as those in FIG. 1 are indicated by the same reference numerals.

The device 1 shown in FIG. 2 for producing a gas mixture with hydrogen comprises a reactor vessel 20. The reactor vessel 20 comprises an upright circumferential wall, which is closed off by a bottom part 31 and a top part 32. The reactor vessel 20 has in the top part 32 an inlet aperture 24 for the flushing fluid, which comprises, for example, steam and nitrogen. A discharge aperture 28 for the retentate stream is provided in the bottom part 31.

The circumferential wall of the reactor vessel 20 has a supply aperture 27 for the supply of the supply stream. The supply stream can comprise any gas mixture from which hydrogen can be released. In this exemplary embodiment the supply stream comprises natural gas and water. An inlet aperture 21 for the supply of air is provided in the circumferential wall of the reactor vessel 20. A lateral outlet 25 for the permeate stream is also provided in the circumferential wall of the reactor vessel 20.

A number of tubular combustion chambers 5 are suspended inside the reactor vessel 20. Each tubular combustion chamber 5 is bounded by a hydrogen-permeable membrane 3, which is self-contained. The membranes 3 form membrane tubes. The reaction chamber 2 with the catalytic bed of catalyst particles 7 extends between said membrane tubes 3 (see FIG. 3).

As illustrated most clearly in FIGS. 3 and 4, each combustion chamber 5 is provided with a tubular supply line 9. The supply lines 9 are each connected to the inlet aperture 21 for air. Each tubular supply line 9 has lateral supply apertures 10 for the supply of air, the supply apertures 10 being provided in the circumferential wall of the supply line 9. The supply apertures 10 are distributed along the length of each supply tube 9. The air is distributed through the supply apertures 10 over the height of the combustion chambers 5. This is particularly advantageous for the temperature distribution over the reaction chamber 2.

Each tubular supply line 9 has a central tube 30 for the passage of the flushing fluid to the bottom part 31 of the reactor vessel 20. The central tube 30 of each supply line 9 is connected to the inlet aperture 24 for the flushing fluid. The flushing fluid flows from said inlet aperture 24 through the central tubes 30 to the bottom part 31 of the reactor vessel 20. The inlet 14 for the flushing fluid of the combustion chambers 5 is situated near the bottom part 31. The sweep flows from the bottom upwards through the combustion chambers 5. From the inlet aperture 21 air flows into the annular channel between the central tube 30 and the supply line 9.

In the reaction chamber 2 the supply stream is converted, for example by steam reforming. Hydrogen is formed in the process. The hydrogen penetrates into the combustion chambers 5 through the membranes 3. A portion of the hydrogen serves as fuel for the combustion in the combustion chambers 5. The remaining hydrogen is entrained upwards as permeate with the flushing fluid. The permeate leaves the combustion chambers 5 through the outlets 15. The outlets 15 of the combustion chambers 5 are connected to the outlet aperture 25 of the reactor vessel 20, with the result that the permeate is discharged.

This device for producing a gas mixture with hydrogen has at least two applications, namely electricity production and ammonia production.

In the case of electricity production the hydrogen discharged from the device 1 is part of the fuel burned in a gas turbine of a power station.

For ammonia production the hydrogen discharged from the device I is supplied to an ammonia reactor. For the production of ammonia (NH₃) the quantity of air to be supplied to the combustion chambers is fixed. The supply air contains nitrogen, the quantity of which is limited because the ratio of nitrogen (N₂) to hydrogen (H₂) for ammonia production is substantially 1:3. This means that the portion of the hydrogen that can combust in the combustion chambers is relatively small. For that reason, in the case of ammonia production in particular, an additional heating unit could be added, such as a separate combustion space. Air or oxygen can also be supplied to the reaction chamber, so that exothermic conversion of the supply stream occurs there; a quantity of natural gas is, for example, combusted in the reaction chamber in order to generate heat.

Of course, the invention is not limited to the exemplary embodiments described above. For example, the reaction chamber can be situated centrally inside the combustion chamber. The combustion chambers are then provided outside the membrane tubes. The reactor device according to the invention can also have a flat geometry. The membranes and the supply channel in that case are flat, while the combustion chamber extends between them.

The invention also comprises all equilibrium reactions in which hydrogen is formed as reaction product in a reaction chamber, and wherein the equilibrium shifts when hydrogen is removed from the reaction through a hydrogen selective membrane. The hydrogen removed consequently passes into a second reaction chamber. In said second reaction chamber a reaction is carried out for the consumption of hydrogen, wherein a reactant for said reaction is supplied through the lateral supply apertures of the supply channel.

In the second reaction chamber various reactions can occur, for example a combustion reaction. The second reaction chamber in this case forms a combustion chamber, in which a fluid containing oxygen (O₂) is supplied to the combustion chamber. The hydrogen on the permeate side of the membrane is then combusted.

If an endothermic equilibrium reaction is being carried out in the reaction chamber, the combustion in the combustion chamber generates heat for maintaining S said endothermic reaction. In addition, the partial pressure of hydrogen on the permeate side remains low. A low partial pressure of hydrogen in the combustion chamber is advantageous for the conveyance of hydrogen through the membrane.

The reaction in the reaction chamber does not have to be endothermic. The combustion of hydrogen on the permeate side in the case of an exothermic reaction in the reaction chamber leads to an increase in the temperature of the gas on the permeate side and on the supply side. Through the metered supply of the oxygen containing gas, the temperature rise in at least the combustion chamber is even. An example of such a reaction is the water gas shift reaction.

1-30. (canceled)

31. A reactor device, comprising a reaction chamber for carrying out a reaction with hydrogen (H₂) as reaction product, a combustion chamber, and a hydrogen-permeable membrane, which is provided between the reaction chamber and the combustion chamber, characterized in that a supply channel is provided in the combustion chamber, which supply channel is provided with lateral supply apertures for supplying a fluid containing oxygen (O₂) to the combustion chamber.

32. The reactor device as claimed in claim 31, wherein the combustion chamber is situated on the permeate side of the hydrogen-permeable membrane.

34. The reactor device as claimed in claim 31, wherein the combustion chamber is designed for combusting hydrogen which is conveyed out of the reaction chamber through the hydrogen-permeable membrane.

34. The reactor device as claimed in claim 31, wherein the combustion chamber is thermally in contact with the reaction chamber by way of the hydrogen-permeable membrane.

35. The reactor device as claimed in claim 31, wherein the combustion chamber is provided with an inlet aperture for the fluid containing oxygen (O₂), which inlet aperture is connected to the supply channel with the lateral supply apertures.

36. The reactor device as claimed in claim 31, wherein the combustion chamber is provided with an inlet for a flushing fluid, such as steam and/or nitrogen and/or a fluid containing oxygen (O₂), such as air.

37. The reactor device as claimed in claim 31, wherein the combustion chamber is provided with an outlet for at least hydrogen, which is conveyed out of the reaction chamber through the hydrogen-permeable membrane.

38. The reactor device as claimed in claim 31, wherein the reaction chamber is provided with a supply for supplying a supply stream.

39. The reactor device as claimed in claim 31, wherein the reaction chamber is provided with a discharge for discharging non-reacted supply stream and products and by-products formed by the reaction, such as CO₂, H₂O, H₂, CH₄ and CO.

40. The reactor device as claimed in claim 31, wherein the reaction chamber and/or the combustion chamber is/are provided with a catalytic bed.

41. The reactor device as claimed in claim 31, wherein the supply channel comprises a tubular supply line.

42. The reactor device as claimed in claim 31, wherein the reaction chamber is designed for an endothermic reaction.

43. The reactor device as claimed in claim 42, wherein the lateral supply apertures are designed in such a way that the heat production through combustion of hydrogen in the combustion chamber is adapted to the heat requirement of the endothermic reaction in the reaction chamber.

44. The reactor device as claimed in claim 31, wherein the supply apertures are provided at substantially unequal distances from each other.

45. The reactor device as claimed in claim 31, wherein a supply for supplying a fluid containing oxygen (O₂) is provided in the reaction chamber.

46. The reactor device as claimed in claim 31, comprising a reactor vessel that is provided with a number of hydrogen-permeable membranes, each membrane bounding a combustion chamber, wherein the reaction chamber extends between the combustion chambers, and wherein each combustion chamber is provided with a supply channel that is provided with lateral supply apertures for supplying fluid containing oxygen (O₂) to said combustion chambers.

47. The reactor device as claimed in claim 46, wherein the reactor vessel has a supply aperture for a supply stream which opens into the reaction chamber between the combustion chambers bounded by the hydrogen-permeable membranes (3).

48. The reactor device as claimed in claim 46, wherein the hydrogen-permeable membranes are each suspended substantially vertically in the reactor vessel.

49. The reactor device as claimed in claim 31, wherein the hydrogen-permeable membrane bounds a tubular combustion chamber.

50. The device as claimed in claim 47, wherein each tubular supply line is provided with at least one central tube for passing through flushing fluid to an end part of the reactor vessel, which central tube extends inside the supply line, and wherein the inlet for the flushing fluid of each combustion chamber is provided in said central tube near the end part.

51. A method for carrying out a reaction, wherein hydrogen (H₂) is formed as reaction product, comprising:
providing a reaction chamber and a combustion chamber, which chambers are separated from each other by a hydrogen-permeable membrane, which combustion chamber has a supply channel for a fluid containing oxygen (O₂) which is provided with lateral supply apertures,
carrying out said reaction in the reaction chamber,
conveying hydrogen from the reaction chamber to the combustion chamber (5) through the hydrogen-permeable membrane,
supplying fluid containing oxygen (O₂) to the combustion chamber through the supply apertures (10) of the supply channel,
combusting a quantity of the hydrogen conveyed through the hydrogen-permeable membrane in the combustion chamber with the release of heat,
transferring said heat to the reaction chamber.

52. The method as claimed in claim 51, wherein said heat is transferred from the combustion chamber to the reaction chamber by means of heat conduction through the hydrogen-permeable membrane.

53. The method as claimed in claim 51, wherein the reaction carried out in the reaction chamber is endothermic, and wherein the heat transferred to the reaction chamber is used for maintaining said endothermic reaction.

54. The method as claimed in claim 51, wherein the reaction carried out in the reaction chamber is exothermic.

55. The method as claimed in claim 51, wherein the reaction carried out in the reaction chamber is an equilibrium reaction.

56. The method as claimed in claim 51, wherein a flushing fluid, such as steam and/or nitrogen and/or a fluid containing oxygen (O₂), such as air, is fed through the combustion chamber.

57. The method as claimed in claims 51, wherein hydrogen is discharged from the combustion chamber through an outlet.

58. The method as claimed in claim 57, wherein the hydrogen discharged from the combustion chamber is supplied to a gas turbine for generating electricity.

59. The method as claimed in claim 57, wherein the hydrogen discharged from the combustion chamber is supplied together with nitrogen to an ammonia reactor for producing ammonia (NH₃).

60. The method as claimed in claims 51, wherein syngas is discharged from the reaction chamber through a discharge.
